(19) United States
(12) Patent Application Publication
(10) Pub. No.: US 2004/0098179 A1
(43) Pub. Date: May 20, 2004

(54) Vehicle security device

(76) Inventors: Darren Scott Sokoloski, Burnaby (CA); Curtis Michael Robin, Vancouver (CA)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 10/298,163

(22) Filed: Nov. 14, 2002

(51) Int. Cl. G06F 7/00

(52) U.S. Cl. 701/29; 701/36; 700/11

(57) ABSTRACT

An energy exchange system includes a plurality of service ports, each receptive to a connectivity device. The connectivity device physically connects a vehicle to the energy exchange system for exchanging energy services. Each vehicle using the energy exchange system is known to the system. Consequently, a vehicle may be secured to the service port to prevent theft in the case of home or parking lot service ports and to retain vehicles reported stolen in the case of other service locations, such as fast-fill stations. Associated with the energy exchange process is a clamping of the connectivity device. Disabling of the clamp release in response to a vehicle stolen or unauthorized use status, prevents the vehicle from being removed from the service port. Additional measures such as disabling the vehicle drive train or fuel system may be used to further ensure that the vehicle is retained.

### FIELD OF THE INVENTION

The present invention relates to vehicle security, and is particularly concerned with a device associated with vehicle docking for servicing such as recharging or refueling.

### BACKGROUND OF THE INVENTION

Typically vehicle security systems depend upon a device that prevents the vehicle from being operated, until the owner or appropriate user disarms the security system with a physical key, numeric code, or other input key. For example security features may include interrupting the power to ignition and/or fuel pump.

An unauthorized user can typically defeat these systems by bypassing the security circuit, removing the security device's source of power (vehicle battery, or secondary battery), or simply by towing the vehicle away. Typical security systems also depend on audible alarm or remote alarm notification to alert the vehicle owner or appropriate authority that the vehicle is being tampered with.

### SUMMARY OF THE INVENTION

An object of the present invention is to provide an improved vehicle security device.

In accordance with an aspect of the present invention there is provided a docking mechanism for making a physical connection with a service port when the vehicle is parked, a first controller for controlling the service port, a second controller, and a data communications link selectively coupling the first and second controllers.

In accordance with an aspect of the present invention there is provided a method of providing vehicle security in an energy exchange system including a plurality of service ports, each vehicle having a connectivity device for coupling to any of the service ports with the coupling controlled by a controller, the method comprising the steps of: coupling the connectivity device to the service port; clamping a portion of the connectivity device to the service port; identifying whether a vehicle has a stolen status; and disabling release of the portion of the connectivity device to secure the vehicle to the service port in response to the stolen status.

In accordance with an aspect of the present invention there is provided a system for providing vehicle security comprising: an energy exchange system including a plurality of service ports, each having a clamping mechanism; a vehicle having a connectivity device for coupling to any of the service ports; a controller associated with one of the vehicle and any of the service ports for controlling coupling and identifying the vehicle controller having a first module for releasing the clamping mechanism and a second module responsive to a vehicle stolen status for disabling the first module.

An advantage of the present invention is providing vehicle security through addition of a software module to a vehicle energy exchange system. Consequently, security upgrades and enhancements can be provided quickly and cost effectively.

### BRIEF DESCRIPTION OF THE DRAWINGS

The present invention will be further understood from the following detailed description with reference to the drawings in which:

FIG. 1 illustrates in a system block diagram, a service terminal and a terminal-compatible vehicle, wherein liquid and gaseous fuels, water, electricity and data are exchangeable between the terminal and the vehicle;

FIG. 2 illustrates in a perspective view, a wheel stop service port of the service terminal in FIG. 1;

FIG. 3 illustrates in a perspective view, a connectivity device mountable to a vehicle;

FIG. 4 illustrates in an energy exchange network including a coupling system;

FIGS. 5a, 5b, 5c illustrate, in cross-sectional side views, the wheel stop service port of FIG. 2 with the connectivity device of FIG. 3;

FIG. 6 illustrates in a flow chart, a basic precedence for providing vehicle security in accordance with an embodiment of the present invention;

FIG. 7 illustrates a procedure for providing security at a home located terminal in accordance with a second embodiment of the present invention;

FIG. 8 illustrates a procedure for providing security at a fast-fill station in accordance with a third embodiment of the present invention; and

FIG. 9 illustrates an example of an energy exchange network user profile in accordance with an embodiment of the present invention.

### DETAILED DESCRIPTION OF THE PREFERRED EMBODIMENT

An energy exchange system as described includes a service terminal for coupling vehicles to exchange energy services, the service terminal including vehicle coupling hardware and connection to energy service provider systems, and an energy exchange network governing the control and management of energy exchange between the connected systems.

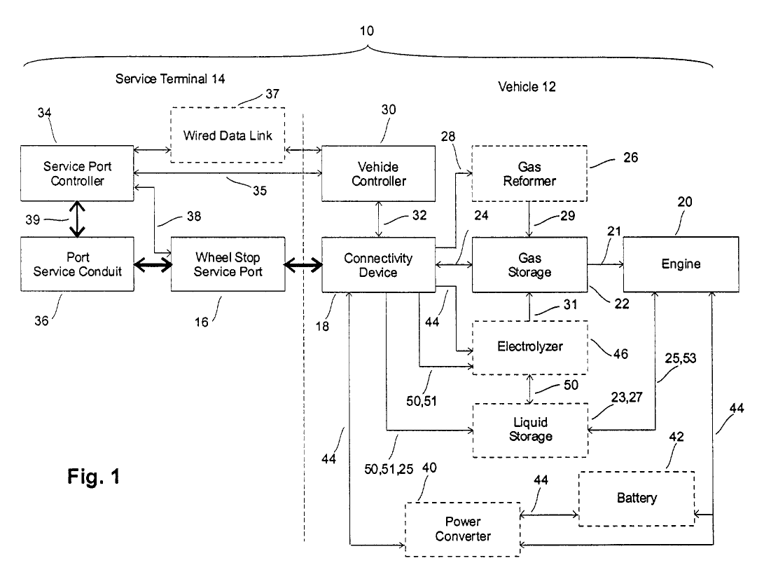

FIG. 1 illustrates an embodiment of a system 10 for transferring one or more of energy, material or data (collectivity referred to as “services”) between system-compatible vehicles 12 and a stationary service terminal 14. The service terminal 14 may be integrated into a building or pre-existing structure, or be part of a dedicated vehicle service terminal facility or be part of a mobile vehicle service port. In each embodiment, the service terminal 14 has a wheel stop service port 16 and the vehicle 12 has a connectivity device 18 that can couple to the wheel stop service port 16. Other major components of the service terminal 14 include a service port controller 34 for controlling the transfer of services by the wheel stop service port 16, and a port service conduit 36 for coupling the service terminal to one or more service destinations (not shown). The destination may be a service source when the service is to be transferred from the source to the vehicle 12; for example, the service source may be a fuel tank that supplies fuel to the vehicle when coupled to the service terminal 14. Or, the destination may be a service consumer when the service is to be transferred from the vehicle 12 to the consumer; for example, the service terminal 14 may be connected to a power grid, and the consumer may be an electricity user connected to the grid that receives electricity generated by a fuel cell onboard the vehicle and transferred to the grid when the vehicle is connected to the service terminal.

The system 10 is particularly suitable for providing services to fuel cell and regenerative fuel cell vehicles, but can also serve vehicles powered by other means, such as natural gas, liquid fuels, electricity, etc. The vehicle 12 has a number of components that make it compatible with the service terminal 14; the type of components depend on what services are being transferred.

FIG. 1 illustrates an embodiment of a system 10 that is capable of transferring one or more of gaseous and liquid fuel, water, electrical energy and data between a service terminal 14 and a vehicle 12. The vehicle 12 may include some or all of the components as described in the systems illustrated in FIG. 1. The connectivity device 18 may include one or a combination of the service connections as described below. The wheel stop service port 16 has interfaces for at least gaseous fuel, liquid, electricity and data. The wheel stop service port 16 is suitable to work with the connectivity device 18 of any vehicle, regardless of the maximum number of service connections on the connectivity device 18. An additional function of the system 10 is that the type of connectivity device 18 and the type of service required is determined by communication between the vehicle controller 30 and the service port controller 34. The service port controller 34 provides control signals through the control signal wire 38 to the wheel stop service port 16 directly, or via control signal wire 39 and port service conduit 36 to control the transfer of only those services suitable for the identified connectivity device 18.

The connectivity device 18 is electrically communicative with a vehicle controller 30 via control signal wire 32, which controls operation of the connectivity device 18; for example, the vehicle controller 30 provides automatic connection and gas transfer control signals to control the transfer of gaseous fuel through the connectivity device 18. The vehicle controller 30 has a transceiver (not shown) to exchange data wirelessly with a transceiver (not shown) in a service port controller 34 of the service terminal 14 (wireless link shown as 35). The construction of the controllers 30, 34 are known in the art. Optionally, a wired data link 37 may be substituted for the transceivers; in such case, data line connection points (not shown) are provided on each of the wheel stop service port 16 and the connectivity device 18 that connect when the wheel stop service port 16 and the connectivity device 18 are coupled or alternatively data can be sent over the electrical power connections. The data communicated to and from the vehicle controller 30 relates to providing data-related services that include vehicle identification (ID), and fueling processes.

The connectivity device 18 has a gas transfer port (not shown) that is sealably connectable to a gas transfer port (not shown) of the wheel stop service port 16 to enable the transfer of gas between the vehicle 12 and the service terminal 14. The connectivity device 18 is connected to a gas storage cylinder 22 by way of gas line 24. Gas line 24 is bi-directional to enable fuel to be transmitted from the service terminal 14 to the vehicle 12, or vice versa. The gas storage cylinder 22 is fluidly connected to the engine 20 by way of gas transfer line 21. In one embodiment, gaseous fuel is transferred and reformed so that constituents such as hydrogen gas can be stored on-board the vehicle. A gas reformer 26 is provided that is connected to the connectivity device 18 via gas line 28, and connected to the gas storage cylinder 22 via gas line 29, so that gaseous fuel transmitted from the wheel stop service port 16 can be first reformed before being stored in the gas storage cylinder 22 and used by the engine 20.

An embodiment of the service terminal is to provide the function of electricity transfer to or from the vehicle, for the purposes of powering onboard electrolysis or storage charging, and for transferring generated electricity from the vehicle back through the service terminal. In this case, the connectivity device 18 is configured to transmit electric power between the service terminal 14 and the vehicle 12, and the vehicle controller 30 is configured to control the transmission of electrical energy by the connectivity device 18. Electrical cables 44 electrically couple the connectivity device 18, power converter 40, battery 42, and the engine 20. Similarly, the wheel stop service port 16 is configured to transmit electric power between the service terminal 14 and the vehicle 12, and the service port controller 34 is configured to control the transmission of energy by the wheel stop service port 16.

A potential use of the service terminal is to transfer liquid fuel such as gasoline. The connectivity device 18 is configured to transfer liquid fuel between the service terminal 14 and the vehicle 12, and the vehicle controller 30 is configured to control the transmission of liquid by the connectivity device 18. Similarly, the wheel stop service port 16 is configured to transmit liquid fuel between the service terminal 14 and the vehicle 12, and the service port controller 34 is configured to control the transmission of liquid fuel by the wheel stop service port 16. A liquid fuel storage tank 23 and liquid fuel lines 25 are designed to store and transmit liquid fuel as known in the art.

The service terminal, in an embodiment, may transfer water or other liquids to the vehicle for onboard electrolysis for hydrogen generation. A fluid storage tank 27 is provided to store water transferred from the service terminal 14, an electrolyzer 46 is provided to electrolyze the water to produce hydrogen gas, and a gas storage cylinder 22 is provided to store the hydrogen gas for use by the engine 20. Hydrogen fuel lines 21, 31 fluidly connect the gas storage cylinder 22 to the electrolyzer 46 and engine 20 respectively, and fluid supply and return lines 50, 51 fluidly connect the fluid storage tank 27 to the connectivity device 18 and the electrolyzer 46 respectively. Water is supplied to the vehicle 12 as hydrogen feedstock for the electrolyzer 46 via liquid supply line 50, and unused water from the electrolyzer 46 is returned through liquid return line 51. Water line 53 connects the fluid storage tank 27 to the engine 20 to return product water from the engine 20 and to supply water to humidify the gas stream. Both the connectivity device 18 and the wheel stop service port 16 are configured to transfer liquid and electricity between the service terminal 14 and the vehicle 12. Electrical cables 44 electrically connect the connectivity device 18 to the electrolyzer 46. The vehicle controller 30 is configured to control the operation of the connectivity device 18 to transfer water and electricity for the operation of the electrolyzer 46. The electrolyzer 46 is fluidly connected to the gas storage cylinder 22 through gas line 31.

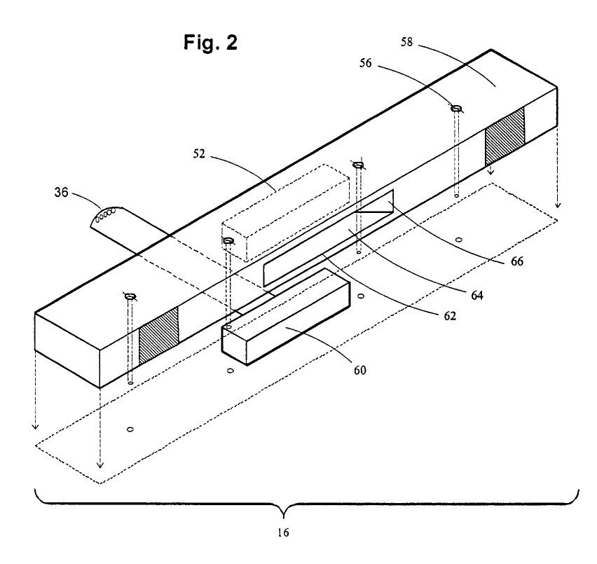

Referring to FIG. 2, the wheel stop service port 16 serves as a ground-mounted stationary docking location for vehicles 12 equipped with compatible connectivity devices 18. Such vehicles 12 couple to the wheel stop service port 16 and bi-directionally transfer services between the service terminal 14 and the vehicle 12. As mentioned, these services include electrical power, gaseous or liquid fuels, water or data. The wheel stop service port 16 is also designed to prevent the wheels of the vehicle 12 from traveling beyond a specific point in a parking stall and to locate the vehicle 12 in a position that places the vehicle's connectivity device 18 in a position for coupling to the service port 16. Other forms of service ports 16 may be used in the overall energy exchange network, including manual connections from service ports.

The wheel stop service port 16 has a generally elongate rectangular wheel stop housing 58 with fastening holes 56. The fastening holes receive a fastener (not shown) for fastening the service port 16 to a parking surface. Near the center of the front surface of the housing 58 is a recess opening 62 that opens into a receptacle recess 52. A connection bay 64 and a receptacle 60 are mounted inside the receptacle recess 52. The connection bay 64 has a front opening in the shape of a rectangular slot, and has tapered walls 66 that taper inwards both vertically and horizontally into the receptacle 60. The front opening of the connection bay 64 is flush with the recess opening 62. The receptacle 60 is mounted inside the receptacle recess 52 behind the connection bay 64 and also has tapered walls (not shown) that taper into the back wall of the receptacle. As discussed in detail below, the tapered walls 66 serve to guide a service plug 70 from the vehicle's connectivity device 18 into a coupling position inside the receptacle 60, i.e., into a position where the plug contacts the back wall of the receptacle.

In this description, the receptacle 60 and plug 70 are collectively referred to as a “service coupling”. Furthermore, the connection bay 64 and receptacle 60 are collectively referred to as the “connection bay assembly”.

The tapered walls 66 act to guide, or “self-locate” the plug 70 into a coupling position, thereby removing the need to provide costly electronic coupling guidance systems. It is understood that other self-locating designs such as a funnel may be substituted for the tapered walls 66 as will occur to one skilled in the art.

The service port 16 is externally controlled by the service port controller 34 via a signal conduit housed inside the service conduit 36. An externally controlled receptacle 60 allows system intelligence such as the service port controller 34 to be located elsewhere, enabling the service port 16 to be economically and easily replaced. Optionally, the service port 16 also has a port status indicator 52 located on the top surface of the housing 58.

The recess opening 62 is located on the front wall of the service port 16 but it may be located anywhere on the wheel stop housing 58. For example, the recess opening 62 may open from the top surface of the housing 58 such that the receptacle 60 and connection bay 64 receive a vertically deployed connectivity device 18.

The receptacle 60 is provided with service exchange interfaces that mate with corresponding service exchange interfaces on the plug 70 to effect a transfer of services therebetween. The service conduit 36 is coupled to the receptacle 60 at the back of the service port 16 and to service sources and/or destinations, thereby enabling the services to be transferred to and from the service port 14 and the service source/destination.

In an alternative embodiment, the service terminal 14 does not include the wheel stop service port 16 and in such case, a service port comprising the connection bay 64 and receptacle 60 are located elsewhere on the service terminal, and the corresponding location of the connectivity device 18 on the vehicle 12 of the alternative embodiment is at a position for coupling to the service port 16.

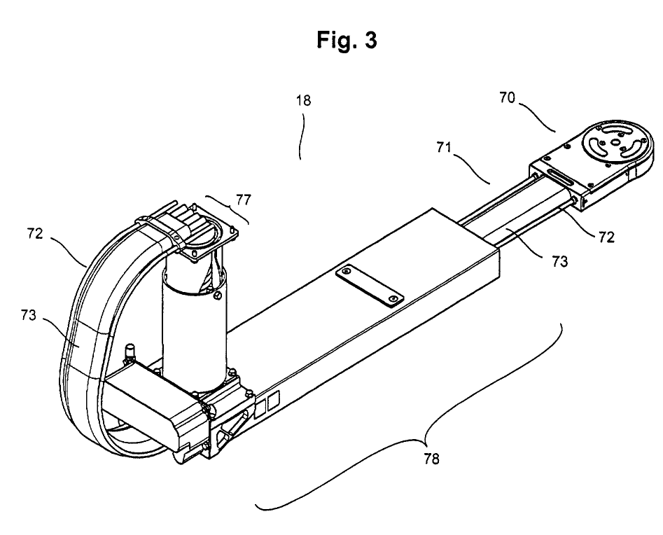

Referring to FIG. 3, the connectivity device 18 is for connecting the vehicle 12 to the service terminal 14 such that services can be exchanged therebetween. In this first embodiment, the connectivity device 18 is mountable to the front underside of the vehicle 12, has means to deploy the connectivity device from the vehicle, and has plug structures to couple to the receptacle 60 on the wheel stop service port 16 when the vehicle is in close proximity to the wheel stop service port. However, it is within the scope of the invention to mount the connectivity device 18 to a different part of the vehicle 12, or to mount the receptacle 60 to a different part of the service terminal 14. It is also within the scope of the invention to locate the connectivity device 18 on the wheel stop service port 16, and locate the receptacle 60 on the vehicle 12; in such case, the connectivity device extends from the wheel stop service port to couple to the vehicle when the vehicle is in close proximity to the wheel stop service port.

The major components of the connectivity device 18 are a plug 70 for coupling to the receptacle 60 of the service terminal 14, a compliant member 71 attached at one end to the plug, a deployment apparatus 78 attached to the compliant member for deploying the plug from a stored position into a deployed position and retracting same back into the stored position, and a vehicle mounting assembly 77 attached to the deployment apparatus 78 and mountable to the underside of the vehicle 12.

The compliant member 71 comprises a pair of flexible water lines 72 and flexible electrical cables 73 having a plurality of flexible electrical power conductors (not shown) housed within a protective jacket. The water lines 72 and the power conductors are coupled to components of the vehicle 12 that use or supply water and/or electricity. For example, the water lines 72 and electrical cables 73 may be connected to the on-board electrolyzer 46 to supply feedstock water and power the electrolyzer 46, respectively. Another option is that a hydrogen supply line is provided (not shown) for the purpose of direct fueling of the vehicle from a stored source of hydrogen.

In operation, the service coupling is engaged whenever the vehicle parks at a service port 16. The vehicle is typically parked at a service port 16 for fueling although it may also be parked to enable the transfer of information from or to the service port controller 34 and network controller (not shown in the figures). The connectivity device 18 is inserted into the receptacle 60 and is physically clamped in place by the clamp actuator (not shown) in the wheel stop service port 16. Typically the wheel stop service port 16 is fixed to the ground or parking structure and receives power from a fixed line. Thus the wheel stop service port 16 is able to physically fix the vehicle 12 in place independent of the vehicle power supply or vehicle engine systems. The docking process allows only an authorized user to unlock the docking mechanism. User authorization may be determined using a variety of techniques, such as: user ID and password; card and personal identification number (PIN); or biometric scan.

In one form of the invention the wheel stop service port 16 is installed at the vehicle owner's residence such that the vehicle can be fueled overnight or can generate power while parked at a private residence.

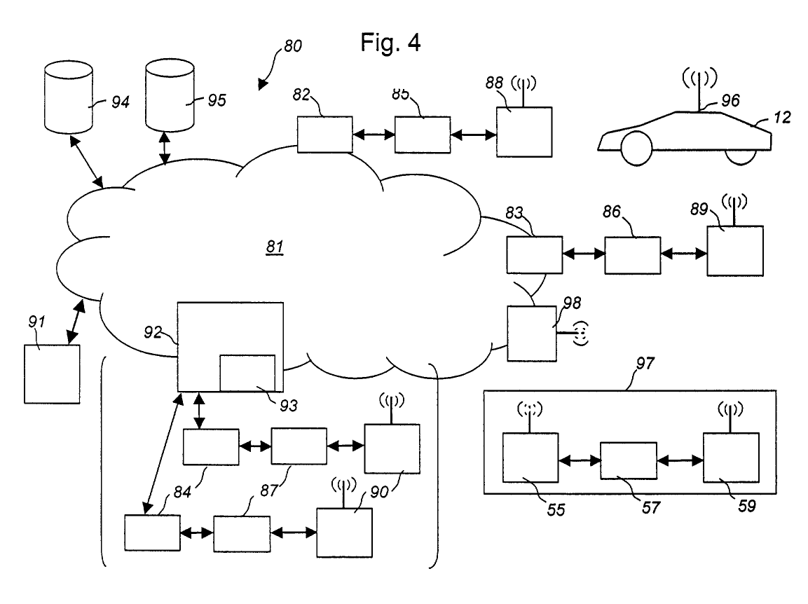

Referring to FIG. 4, there is illustrated an energy exchange network 80 including a coupling system in accordance with an embodiment of the present invention. The coupling systems are located at network nodes corresponding to service terminals 14 that include service port subsystems for communicating and coupling to vehicles 12 accessible to the network. An energy exchange station node controller 92 is located at energy exchange stations (not shown). An energy exchange station controls and manages multiple service ports 16 and coordinates network communications with individual service node controllers 82, 83, 84 at the service port. The station node controller 92 controls access to energy services and are connected to a plurality of service terminals 14 and enable management of local energy and services by the service terminals at that energy exchange station. An energy exchange network 80 includes a plurality of energy exchange network servers 91, a plurality of service node controllers 82, 83, 84, each coupled to an energy exchange network server via the wide area network 81. The wide area network 81 may include combinations of a private or public network, and technologies such as wireless, dialup, wired, satellite, broadband or internet systems. Service node controllers 82, 83 and 84 are coupled to access controllers 85, 86, 87, which in turn are coupled via node transceivers 88, 89, 90 to vehicles 12 provided with a corresponding communications transponder 96 or transponders 96. The access controllers 85, 86, 87 restrict services of their respective service node controllers 82, 83, 84 according to authorizations associated with potential users, such as a user corresponding to node transponder 96.

Each node transceiver 88, 89, 90 establishes a wireless local area network (LAN). Each node may be serviced by a single wireless LAN as illustrated in FIG. 4, or may have multiple wireless transceivers establishing multiple wireless LANs.

The energy exchange station node controller 92 is communicable with the service node controllers 84 associated with service terminals 14 located at the energy exchange station (not shown) and may control services provided through the associated service terminals, as well as local energy storage and distribution. In this example, the station node controller 92 communicates directly with the wide area network 81, and the service node controllers 82, 83, 84 communicate requests to the network through the station node controller. The station node controller 92 or individual service node controllers 82, 83, 84 may have a local cache 93 for storing authorization data and profiles, to enable services even when there is no connection to the network 81.

In either case, access to service node controllers 82, 83, 84 or via the wireless LAN is restricted by access controllers 85, 86, 87. Once the user corresponding to transponder 96 has docked the vehicle 12, a physical connection can optionally be established to support a data link between the access controller 85, 86, 87 and the transponder, consequently at least some of the ports can be accessed through a wired port in the vehicle coupling.

The energy exchange network server 91 provides energy services and management of distributed energy exchange transactions, manages transactions with energy service providers 94 and 95 (ESP) including buy and sell orders, and manages the energy exchange network 80 and service node controllers 82, 83, 84. Typically, a plurality of energy exchange network servers 91 is connected to the wide area network 81 to maintain a large scale of users and transactions. Data related to energy service providers 94 and 95 may be accessed via the energy exchange network 80 and the wide area network 81 and used to control buying and selling energy between the networked subsystems of the energy exchange network.

Users of the energy exchange network 80 may access the network through any of the energy exchange nodes or energy exchange network connections and may include ESP's, service providers, owners of service ports, vehicle owners and network managers.

In another embodiment, a mobile service node controller 55, similar in function to the above described stationary energy exchange service nodes, may be located in a mobile service port 97 to provide networked energy services. The function of the mobile service port 97 is to provide energy exchange, roadside support, fleet fueling, defueling, and emergency services to vehicles or other devices that require such services distant from a stationary energy exchange service system. In this embodiment, the wide area network 81 includes a second wireless network for mobile communications 98, which communicates wirelessly with the mobile service port 97 by way of a wireless connection with a mobile service node controller 55. The wireless connection between the network for mobile communications 98 and the mobile service node controller 55 is effected by commonly available mobile communications including cellular or satellite networks. The mobile service node controller 55 is in turn coupled to a mobile access controller 57, which in turn is coupled via mobile node transceiver 59 to vehicles 12 provided with corresponding communications transponder 96 or transponders 96. The mobile service port 97 includes an automated service port 16 that is automated, and optionally a service port with manual connection.

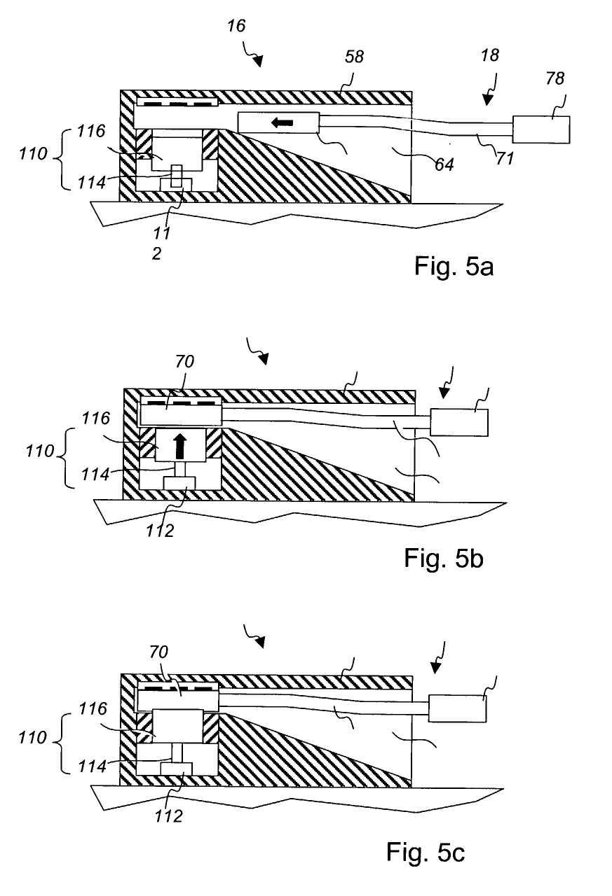

Referring to FIGS. 5a, 5b, and 5c, there are illustrated in cross-sectional diagrams, the wheel stop service port 16 of FIG. 2 coupling with the connectivity device 18 of FIG. 3. The cross-sectional diagrams of FIGS. 5a, 5b, and 5c show the wheel stop service port 16 includes a receptacle 64 for receiving the plug 70 of the connectivity device 18. The wheel stop service port 16 also includes a clamp actuator 110 for exerting a force, directed toward the plug 70 to ensure engagement with the receptacle 64. The clamp actuator 110 as illustrated includes a drive 112, a lead screw 114 and a cylinder 116, however other forms of clamp actuator 110 would be apparent to one of ordinary skill. For example, a hydraulically or pneumatically driven cylinder 116 could be used. Alternatively, the plug 70 could be configured to incorporate a clamp actuator, for example pneumatically driven, that would expand the plug to mate with the receptacle 64. Other alternatives are also possible such as a symmetrical plug 70 and receptacle 64, with each having a corresponding engaging surface and one or both having a clamp actuator 110. The plug when clamped or secured to the receptacle is referred to as a service coupling (not shown).

In operation, the service coupling is engaged whenever the vehicle 12 parks at a service port 16. The vehicle is typically parked at a service port 16 for refueling although it may also be parked to enable the transfer of information between the service port controller 34 and the network controller (not shown in the figures). The connectivity device 18 is inserted into the receptacle 64 and is physically clamped in place by the clamp actuator 110 in the wheel stop service port 16. There are many suitable mechanical designs to automatically secure the connectivity device in addition to the described clamp as may be contemplated by these of ordinary skill in the art. Typically, the wheel stop service port 16 is fixed to the ground or parking structure and receives power through a fixed electrical cable or conduit 36. Thus the wheel stop service port 16 is able to physically fix the vehicle in place independent of the vehicle power supply or vehicle engine systems. Only an authorized vehicle user is allowed by the system to unlock the docking mechanism. Vehicle or user authorization may be determined using a variety of techniques, such as: user ID and password; access card and personal identification number (PIN); or biometric scan. The docking process can also operate in concert with additional onboard vehicle security systems communicating signals to modify corresponding disable flags at the vehicle controller 30, for example to disable a fueling valve or to disable the drive train.

In one embodiment the wheel stop service port 16 is installed at the vehicle owner's residence or overnight parking such that a connected vehicle 12 can be refueled overnight or can generate power while parked at a private residence and the vehicle is automatically secured by the docking process. Such a system is thus able to prevent the theft of the vehicle from home. The energy exchange system also allows for the vehicle to be connected to a wheel stop service port 16 located in a public parking lot such that vehicles can be refueled or generate power while the vehicle is parked elsewhere than at a private residence. Such a system is thus able to prevent the theft of the vehicle from so-equipped parking lots or structures that are equipped with service ports.

The wheel stop service port 16 can be coupled to a variety of methods with control of the clamp actuator 110 depending upon the type of coupling mechanism.

For example, for home or parking lot use, control of vehicle clamping at an un-powered wheel stop service port 16 may be activated from the vehicle via the connectivity device 18. In this case, an un-powered clamping force generator is contemplated, such as a spring-loaded mechanism with an active release by the connectivity device 18 under the authorized control of the vehicle controller 30.

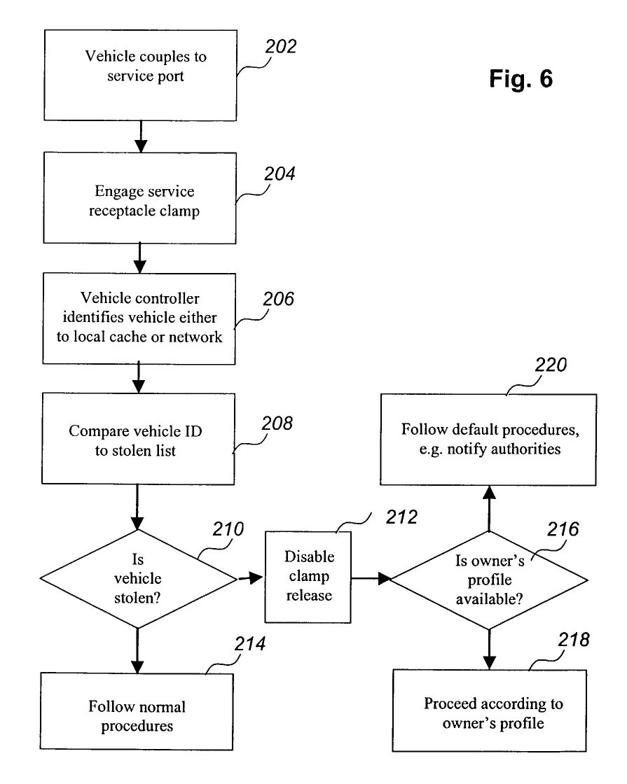

Referring to FIG. 6, a basic procedure for providing vehicle security is illustrated in a flow chart, in accordance with an embodiment of the present invention. The procedure begins with physical coupling to the vehicle as represented by a process block 202. Clamping of the service coupling is effected as represented by a process block 204. The vehicle controller 30 then identifies the vehicle 12, port 16 and station to the service port controller 34, or if there is no local controller, to a network controller via a temporary network connection as represented by a block 206. The local controller (not shown) or network controller (not shown) then compares the vehicle identification (ID) to a list of vehicles and the matching ID is used to determine what services are permitted for the vehicle as shown by a block 208. This step may include the local or network controller querying a local or external network database for the identification and return of profile information related to preferences and use conditions for the identified vehicle. Included in the profile information for the identified vehicle is a “vehicle authorization” flag. An example of the vehicle authorization flag is the “vehicle stolen” status flag. This flag may be set in various ways known to one skilled in the art of database records. For example, a report to the police may, on identifying the vehicle as a member of a group of vehicles associated with a particular vehicle service network, transmit a message to the network controller of the vehicle service network that the vehicle has been reported stolen. Alternatively, the owners of such vehicles may be provided with a remote access device that includes an alert button that can wirelessly communicate to the vehicle service network. By whatever method of notification used, the controller responsible for operating the coupling becomes aware that the vehicle has been reported stolen or unauthorized as represented by block 210, the controller disables the release control as represented by a process block 212; otherwise authorized normal service procedures are followed as represented by a process block 214. Once the release control is disabled, the controller refers to the owner's profile as represented by the decision block 216 to determine further steps to be taken as represented by a process block 218. If for some reason the owner's profile is not available, a default procedure may be implemented as represented by a process block 220, for example, notifying authorities of the current location (as indicated by the port ID and station location) and identification of the stolen or unauthorized vehicle 12.

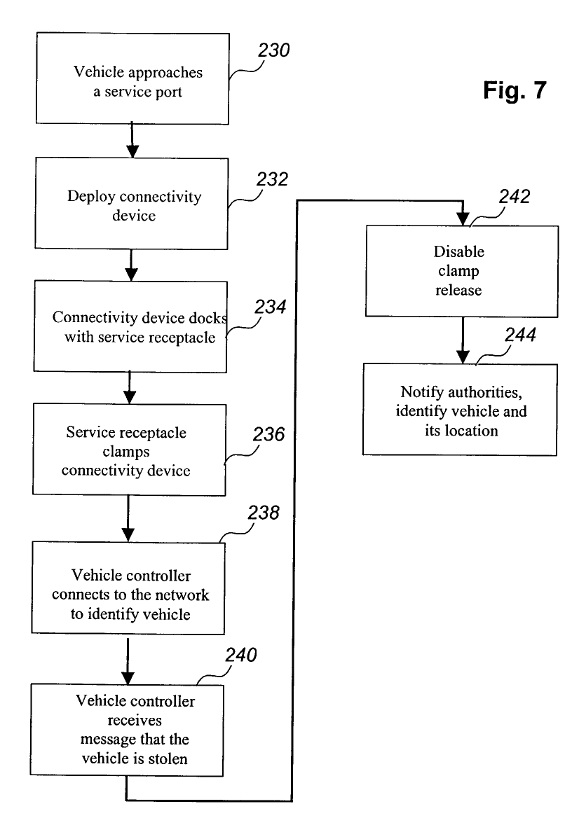

Referring to FIG. 7 there is illustrated a procedure for providing security at a home-located service terminal 14 in accordance with a second embodiment of the present invention. A vehicle enters a home-located parking spot, as represented by a process block 230. This could be at a private garage or outdoor lot, apartment or condominium, and also applies to the general case of a single service terminal without a station. The connectivity device 18 is deployed as represented by a process block 232, and docks with its receptacle 62, as represented by a process block 234. Home-located terminals 14 as described herein are intended to include very basic services, and may rely on a network vehicle controller 30 for operation, network connection and release. Once the vehicle connectivity device 18 has docked, the plug 70 is clamped in position for service, as represented by a process block 236. The clamping could be active or passive in nature, however, for the home-located service terminal, a passive activation of clamping would be more cost effective.

Once the vehicle is in position and clamped the vehicle controller 30 attempts to establish connection to the network as represented by a process block 238. Such connection is typically made for the purposes of energy exchange. Once the network connection is made, the network controller compares the vehicle ID with a list of stolen vehicle IDs, or may retrieve user authorization preferences associated with the vehicle ID. If stolen, or flagged as unauthorized for use, a message is sent from the network to the vehicle controller 30 as represented by a process block 240 that disables the clamp release as represented by a process block 242. If the vehicle ID and the home terminal ID match, based upon the user profile, the network controller then refers to the stored user profile in the database number to determine an appropriate course of action. For example, the network controller may then ask the occupant for authorization, which could take the form of biometric scans, or user identification and pass code, and match the input user authorization to the associated user profile information to proceed and release the vehicle. Otherwise the network controller notifies authorities of the location of the stolen vehicle, as represented by a process block 244. Either of these steps can include additional steps of sending notification messages to the vehicle owner or manual authorization by the user through electronic messages.

Personal identifiers in addition to the vehicle identifier could also be used to ensure authorization for the vehicle use, even when the vehicle status is not stolen, for example at the user's request for an additional level of security or for secure parking purposes, the vehicle is unlocked from the port only following input of a user identification, in addition to the vehicle identification.

A potential scenario for a stolen vehicle is refueling at a fast-fill station that provides fuel directly to the vehicle tank. Such a station could either have a full-time network connection or it could have a local cache memory with network connection via dial-up access. In the latter case, the local cache could receive updates each time the station connected to the network. The local cache could for example retain a list of local vehicles, i.e. regular customers, that would shorten the transaction time and allow service when network connection is not available. The local cache could also retain a list of vehicles that have been reported as stolen.

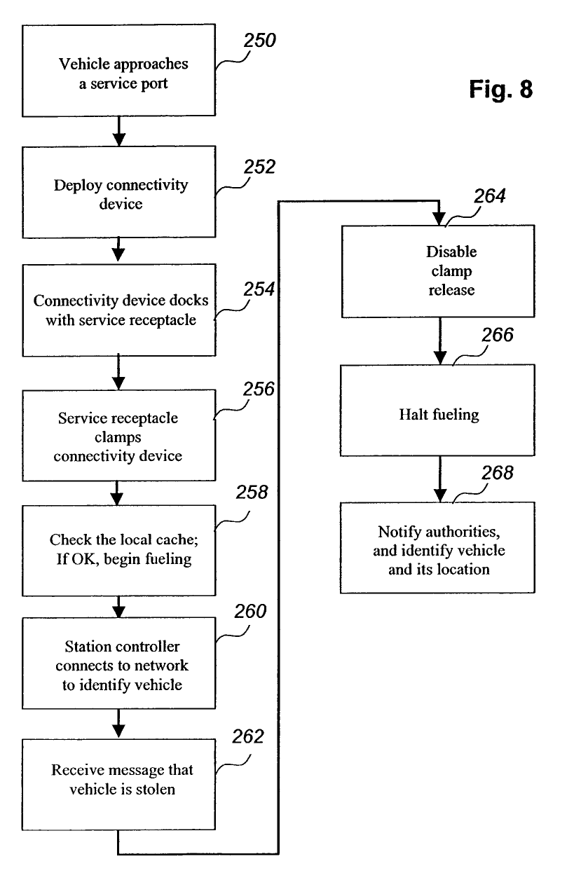

Referring to FIG. 8, there is illustrated a procedure for providing security at a fast-fill station. A vehicle enters a stall that has a wheel stop service port 16, as represented by a process block 250. The connectivity device 18 is deployed as represented by a process block 252 and docks with its receptacle 62, as represented by a process block 254. Fast-fill stations as described herein are intended to deliver fuel directly to the vehicle. Once the vehicle connectivity device 18 has docked, the service plug 70 is clamped in position for service, as represented by a process block 256. The clamping could be active or passive in nature, however for the fast-fill station, an active activation of clamping under the control of the service port controller would be desirable.

Once the vehicle is in position and clamped, the service port controller checks a local cache memory to see whether the identified vehicle is unauthorized or stolen, as represented by decision block 258. If not found to be stolen, fueling proceeds. While the vehicle is fueling, the station connects to the network to provide fueling information as represented by a process block 260. If a message is received from the network that the vehicle is stolen, as represented by a process block 262, fueling is halted as represented by a process block 266 and release of the clamp actuator 210 is disabled as represented by a process block 264.

For a station with an “always-on” network connection, a local cache may not be necessary, hence the service port controller 34 of such a station could skip step 258 and identify the vehicle to the network at 260, and if a stolen message is received at 262, go to step 264, disabling the clamp release, and then go to 268.

Fast-fill stations and vehicles associated therewith may be equipped with wireless communications that allow vehicle identification while the vehicle 12 approaches the station. In this case, identification as stolen may be made prior to docking, hence once the connection is clamped at 256, the procedure could proceed directly to step 264 and then 268.

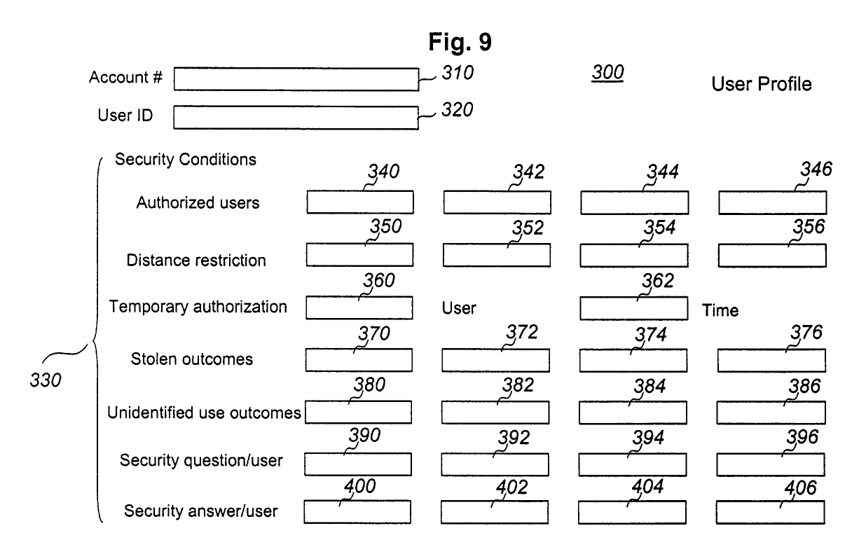

The forgoing examples have used the example of a stolen vehicle, however monitoring of vehicle use in general can also be effected using embodiments of the present invention. This is described in greater detail herein below with reference to FIG. 9.

Additionally, non energy exchange ports, for example in parking lots, could also use the security provided by embodiments of the present invention to offer parking with physically securing for an additional fee. In such an arrangement, only a dial-up access to the energy exchange network is needed to exchange vehicle location and status information.

Referring to FIG. 9, there is illustrated an example of an energy exchange network user profile 300 in accordance with an embodiment of the present invention. The user profile 300 is stored on the database of users and vehicles, and may be copied to other sites, for example to a local cache database of a fueling station. The user profile includes information such as account number 310, user ID 320, and security conditions 330. The security conditions 330 may include:

identification of an authorized users 340-346

operation restrictions for each user 350-356

temporary authorization and time 360-362

vehicle stolen outcome 370-376

unidentified use outcome 380-386

security questions and answers for each user

questions 390-396

answers 400-406

What is claimed is:

1. A method of remotely controlling vehicle use in an energy exchange system including a plurality of fixed service ports, each vehicle having a connectivity device for coupling to any of the fixed service ports with coupling controlled by a controller, the method comprising the steps of:
coupling the connectivity device to the fixed service port; determining a vehicle authorization status; and
securing the connectivity device to lock the vehicle to the fixed service port in response to a predetermined vehicle authorization status.

2. A method of remotely controlling vehicle use as claimed in claim 1, wherein the step of determining includes the step of the controller accessing a local database to determine the vehicle authorization status.

3. A method of remotely controlling vehicle use as claimed in claim 1, wherein the step of determining includes the step of the controller establishing a communication link with a remote database to determine the vehicle authorization status.

4. A method of remotely controlling vehicle use as claimed in claim 1, wherein the energy exchange system includes a communications network and wherein the step of determining includes the step of the controller linking to the communications network and accessing information available via the communications network to determine the vehicle authorization status.

5. A method of remotely controlling vehicle use as claimed in claim 1, wherein the controller is located in the vehicle.

6. A method of remotely controlling vehicle use as claimed in claim 1, wherein a first controller is located in the vehicle and a second controller is co-located with the fixed service port, the step of determining includes the steps of:
establishing a communication link between the first and second controllers;
passing an identifier from the first controller to the second controller; and
comparing the identifier to a database record retrieved by the second controller to determine the vehicle authorization status.

7. A method of remotely controlling vehicle use as claimed in claim 1, further comprising the step of responding to the predetermined vehicle authorization status, and accessing an owner profile for the vehicle to determine additional steps to be taken.

8. A method of remotely controlling vehicle use as claimed in claim 1, further comprising the step of disabling a drive train of the vehicle.

9. A system for remotely controlling vehicle use comprising:
an energy exchange system including a plurality of fixed service ports;
a vehicle having a connectivity device for coupling to any one of the fixed service ports;
a controller associated with one of the vehicle and any one of the fixed service ports for controlling coupling to the vehicle and determining a vehicle authorization status for the vehicle, the controller including a module for securing the connectivity device to the fixed service port, determining the vehicle authorization status and withholding release of the connectivity device to lock the vehicle to the fixed service port in response to a predetermined vehicle authorization status.

10. A system for remotely controlling vehicle use as claimed in claim 9, including a database for storing records of vehicle authorization status.

11. A system for remotely controlling vehicle use as claimed in claim 10, wherein each fixed service port includes a first controller.

12. A system for remotely controlling vehicle use as claimed in claim 11, wherein the energy exchange network includes a data communication network.

13. A system for remotely controlling vehicle use as claimed in claim 12, wherein the first controller for each fixed service port is linked to the data network.

14. A system for remotely controlling vehicle use as claimed in claim 13, wherein each vehicle includes a second controller.

15. A system for remotely controlling vehicle use as claimed in claim 14, wherein the first controller is linked to the second controller while the connectivity device is coupled to the service port.

16. A method of remotely controlling vehicle use in an energy exchange system including a plurality of fixed service ports, each fixed service port having a connectivity device for coupling to any of a plurality of vehicles with coupling controlled by a controller, the method comprising the steps of:
coupling the connectivity device to the vehicle;
determining a vehicle authorization status; and
securing the connectivity device to lock the vehicle to the fixed service port in response to a predetermined vehicle authorization status.

17. A method of remotely controlling vehicle use as claimed in claim 16, wherein the step of determining includes the step of the controller accessing a local database to determine the vehicle authorization status.

18. A method of remotely controlling vehicle use as claimed in claim 16, wherein the step of determining includes the step of the controller establishing a communication link with a remote database to determine the vehicle authorization status.

19. A method of remotely controlling vehicle use as claimed in claim 16, wherein the energy exchange system includes a communications network and wherein the step of determining includes the step of the controller linking to the communications network and accessing information available via the communications network to determine the vehicle authorization status.

20. A method of remotely controlling vehicle use as claimed in claim 16, wherein the controller is located in the vehicle.

21. A method of remotely controlling vehicle use as claimed in claim 16, wherein a first controller is located in the vehicle and a second controller is co-located with the fixed service port, the step of determining includes the steps of:
establishing a communication link between the first and second controllers;
passing an identifier from the first controller to the second controller; and
comparing the identifier to a database record retrieved by the second controller to determine the vehicle authorization status.

22. A method of remotely controlling vehicle use as claimed in claim 16, further comprising the step of responsive to the predetermined vehicle authorization status, accessing an owner profile for the vehicle to determine additional steps to be taken.

23. A method of remotely controlling vehicle use as claimed in claim 16, further comprising the step of disabling a drive train of the vehicle.

24. A system for remotely controlling vehicle use comprising:
an energy exchange system including a plurality of fixed service ports, each having a connectivity device;
a vehicle for coupling to the connectivity device of any one of the fixed service ports;
a controller associated with one of the vehicle and any one of the fixed service ports for controlling coupling to and determining a vehicle authorization status for the vehicle, the controller including a module for securing the connectivity device to the vehicle, determining the vehicle authorization status and withholding release of the connectivity device to lock the vehicle to the fixed service port in response to a predetermined vehicle authorization status.

25. A system for remotely controlling vehicle use as claimed in claim 24, including a database for storing records of vehicle authorization status.

26. A system for remotely controlling vehicle use as claimed in claim 24, wherein each fixed service port includes a first controller.

27. A system for remotely controlling vehicle use as claimed in claim 26, wherein the energy exchange network includes a data communication network.

28. A system for remotely controlling vehicle use as claimed in claim 27, wherein the first controller for each fixed service port is linked to the data network.

29. A system for remotely controlling vehicle use as claimed in claim 28, wherein each vehicle includes a second controller.

30. A system for remotely controlling vehicle use as claimed in claim 29, wherein the first controller is linked to the second controller while the connectivity device is coupled to the vehicle.

31. A system for remotely controlling vehicle use comprising:
a fixed port for coupling to a vehicle having a cooperating member and for establishing a communications path therewith; and
a port controller for identifying the vehicle via the communications path and acquiring a corresponding vehicle authorization status for controlling the port by one of locking and uncoupling the identified vehicle in dependence upon a predetermined vehicle authorization status.

32. A method of remotely controlling vehicle use comprising the steps of:
coupling a fixed port to a vehicle having a cooperating member;
establishing a communications path therewith;
identifying the vehicle via the communications path;
acquiring a corresponding vehicle authorization status; and
controlling the port by one of locking and uncoupling the identified vehicle in dependence upon a predetermined vehicle authorization status.

33. A method of remotely controlling vehicle use comprising the steps of:
subscribing to a security service for a predetermined fee, including establishing a vehicle user profile;
coupling a fixed port to a vehicle having a cooperating member;
establishing a communications path therewith;
identifying the vehicle via the communications path;
acquiring a corresponding vehicle authorization status; and
controlling the port by one of locking and uncoupling the identified vehicle in dependence upon a predetermined vehicle authorization status.

34. A method of remotely controlling vehicle use comprising the steps of:
establishing a vehicle user profile;
coupling a fixed port to a vehicle having a cooperating member;
establishing a communications path therewith;
identifying the vehicle via the communications path;
acquiring a corresponding vehicle authorization status; and
responding to receipt of a transaction fee, controlling the port by one of locking and uncoupling the identified vehicle in dependence upon a predetermined vehicle authorization status.

35. A method as claimed in claim 34 further comprising the steps of monitoring the vehicle via the communication path to determine whether vehicle authorization status needs to be changed and effecting change when needed.

36. A method as claimed in claim 35 wherein the vehicle is a rental vehicle and wherein the step of monitoring includes the steps of determining whether the vehicle is within a predetermined range, and if out of range, changing the vehicle authorization status to a predetermined vehicle authorization status.

37. A method as claimed in claim 35 wherein the vehicle is a lease vehicle and wherein the step of monitoring includes the steps of determining whether the vehicle has a late payment status, and if late, changing the vehicle authorization status to a predetermined vehicle authorization status.
